(19) United States
(12) Patent Application Publication
(10) Pub. No.: US 2007/0153391 A1
(43) Pub. Date: Jul. 5, 2007

(54) Optical module

(76) Inventor: Ping Chuang, Kwei-Shan Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/472,289

(22) Filed: Jun. 22, 2006

(30) Foreign Application Priority Data
Jan. 4, 2006 (TW) 95100374

(51) Int. Cl. G02B 27/10

(52) U.S. Cl. 359/619

(57) ABSTRACT

An optical module is provided. The optical module comprises a light source, a first lens array and a second lens array. The first lens array is located on the light source and the second lens array is located on the first lens array. There are a plurality of curved bumps on the surface of the first lens array. There are a plurality of pyramid bumps on the surface of the second lens array.

### RELATED APPLICATIONS

The present application is based on, and claims priority from, Taiwan Application Serial Number 95100374, filed Jan. 4, 2006, the disclosure of which is hereby incorporated by reference herein in its entirety.

### BACKGROUND

1. Field of Invention

The present invention relates to an optical module. More particularly, the present invention relates to an optical module applied in a backlight module of a liquid crystal display.

2. Description of Related Art

Planar light sources with even brightness are hard to generate because of manufacturing limitations of light sources and light emitting devices such as light emitting diodes (LED), which are point light sources, and cold cathode fluorescent lamps (CCFL), which are linear light sources. When a product requires a planar light source, an optical element that can diffuse light is conventionally present in the product so as to diffuse the light emitted from the light sources. In addition, the product should also comprise another focusing element so that the light can be focused on the front.

A typical example is a backlight module of a liquid crystal display (LCD). Because liquid crystal isn't itself luminescent, a backlight module is used as a light source so that the LCD can be displayed. FIG. 1 is a cross-section schematic diagram showing a traditional back light module of a liquid crystal display. In FIG. 1, a backlight module comprises a light source 102, a light guide substrate 104, a diffuser substrate 106, an enhancer substrate 108 and a reflector 110. First, a light shot from the light source 102 is guided into the light guide substrate 104. After the light is reflected by the reflector 110, the light is diffused by passing through the diffuser substrate 106. Then, the light is focused by passing through the enhancer substrate 108. After the light passes through the diffuser substrate 106 and the enhancer substrate 108, it would pass through the LCD panel (not shown in FIG. 1) and illuminate the LCD.

Another enhancer substrate is added into the traditional backlight module to further improve the front side brightness. FIG. 2 is a cross-section schematic diagram showing a traditional back light module having two enhancer substrates. In FIG. 2, an upper enhancer substrate 109 is located on the enhancer substrate 108. The upper enhancer substrate 109 and the enhancer substrate 108 have striped bumps 114 uniformly distributed in two perpendicular directions, respectively. After the light passes through the enhancer substrate 108 and the upper enhancer substrate 109 in sequence, the interference fringes 120 shown in FIG. 3 are produced. The interference fringe pattern shown in FIG. 3 is known as the “moire effect” and results in vision defects.

Another diffuser substrate, such as an upper diffuser substrate 111 shown in FIG. 2, is added on the upper enhancer substrate to reduce or eliminate the moire effect. However, increasing the number of optical elements up to four films decreases light utilization because light absorbed by the optical elements will increase. The additional material needed for four optical films also increases the manufacturing cost. Furthermore, traditional backlight modules cannot generate uniform brightness at a certain range of visual angle. That is, brightness is decreased and only half of the front side brightness remains if the visual angle is above 25°.

Therefore, there is a need to reduce the number of optical elements and reduce the moire effect, and improve brightness at a certain visual angle to resolve the problems mentioned above.

### SUMMARY

In one aspect, this present invention provides an optical module using two optical elements to achieve the effect that conventionally requires four optical elements.

In another aspect, this present invention provides an optical module that can increase its brightness at a certain visual angle.

In still another aspect, this present invention provides an optical module that can decrease material and manufacturing costs.

In accordance with the foregoing and other aspects of the present invention, the present invention provides an optical module that can be used as a backlight module. The optical module comprises a light source, a first lens array, and a second lens array. The first lens array is located on the light source and the second lens array is located on the first lens array. The first lens array comprises a plurality of curved bumps and cross-sections of the curved bumps are arcs. The second lens array comprises a plurality of pyramid bumps and cross-sections of the pyramid bumps are tapered.

According to one preferred embodiment of the present invention, the curved bumps have an arc height and a cord length, where the ratio of the arc height and the cord length is preferred to be between 0.25 and 0.5, and more preferably 0.5.

According to one preferred embodiment of the present invention, the pyramid bumps have a pointed tip on the top and with a preferred angle θ of the pointed tip between 60° and 120°, and more preferably 90°.

According to one preferred embodiment of the present invention, the first lens array comprises the pyramid bumps according to the demands.

Thus, an optical module of the present invention can provide an increase in its brightness at a certain visual angle and reduce the moire effect. Moreover, to be able to both focus and diffuse light, the scale of the curved bumps of the first lens array and the pyramid bumps of the second lens array are smaller than micro-scale. Furthermore, the optical module of the present invention can achieve the effect that conventionally requires four optical elements to achieve, that is the optical module of the present invention can reduce the number of the optical elements used and decrease material and manufacturing cost. The optical module of the present invention can use only two lens arrays having the same pyramid bumps to enhance its brightness

### BRIEF DESCRIPTION OF THE DRAWINGS

The invention can be more fully understood by reading the following detailed description of the preferred embodiment, with reference made to the accompanying drawings as follows:

FIG. 1 is a cross-section schematic diagram showing a traditional back light module of a liquid crystal display.

FIG. 2 is a cross-section schematic diagram showing a traditional back light module having two enhancer substrates.

FIG. 3 is a schematic diagram showing the moire effect.

FIG. 4A and FIG. 4B are cross-section schematic diagrams showing a back light module according to one embodiment of the present invention.

FIG. 5 is a cross-section schematic diagram showing the enlarged first lens array in FIG. 4A.

FIG. 6 is a cross-section schematic diagram showing the enlarged second lens array in FIG. 4A.

FIG. 7 and FIG. 8 are top view schematic diagrams showing a first lens array according to one embodiment of the present invention.

FIG. 9 and FIG. 10 are top view schematic diagrams showing a second lens array according to one embodiment of the present invention.

FIG. 11A and FIG. 11B are cross-section schematic diagrams showing a back light module according to another embodiment of the present invention.

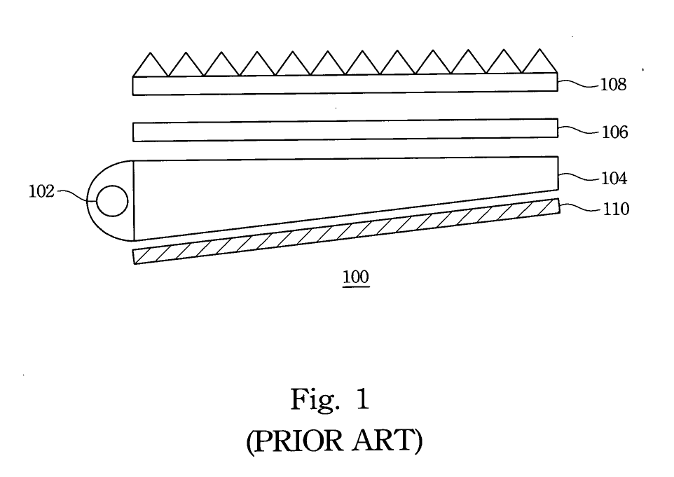

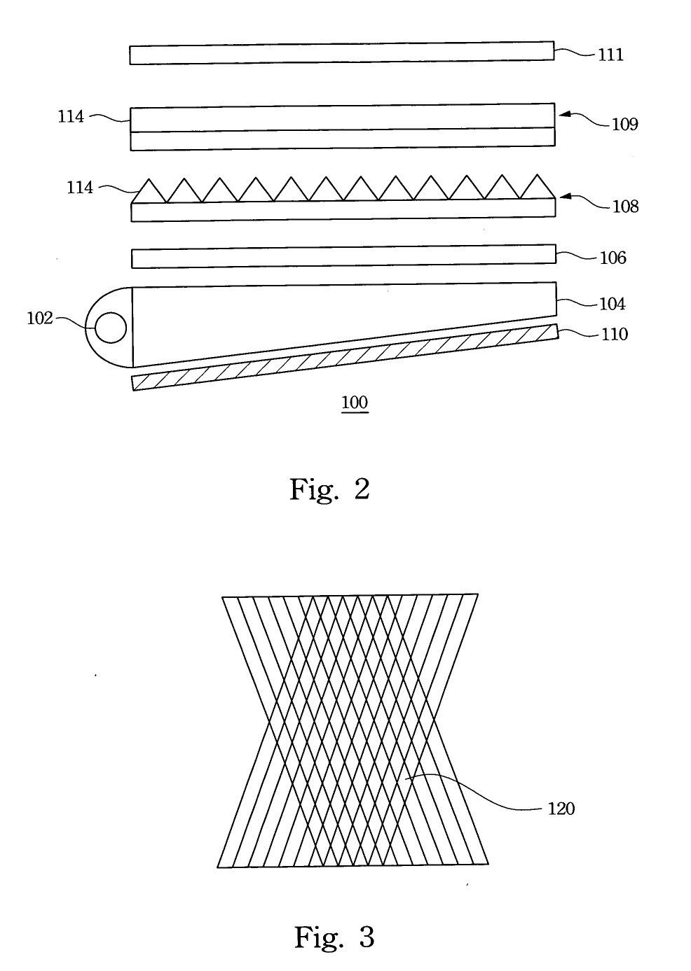

### DESCRIPTION OF THE PREFERRED EMBODIMENTS

The optical module of the present invention can reduce the number of optical elements used and the moire effect, and retain the brightness at a certain range of visual angle. The embodiments provided herein are for description of the use and manufacture of the present invention and should not be used to limit the scope of the claims.

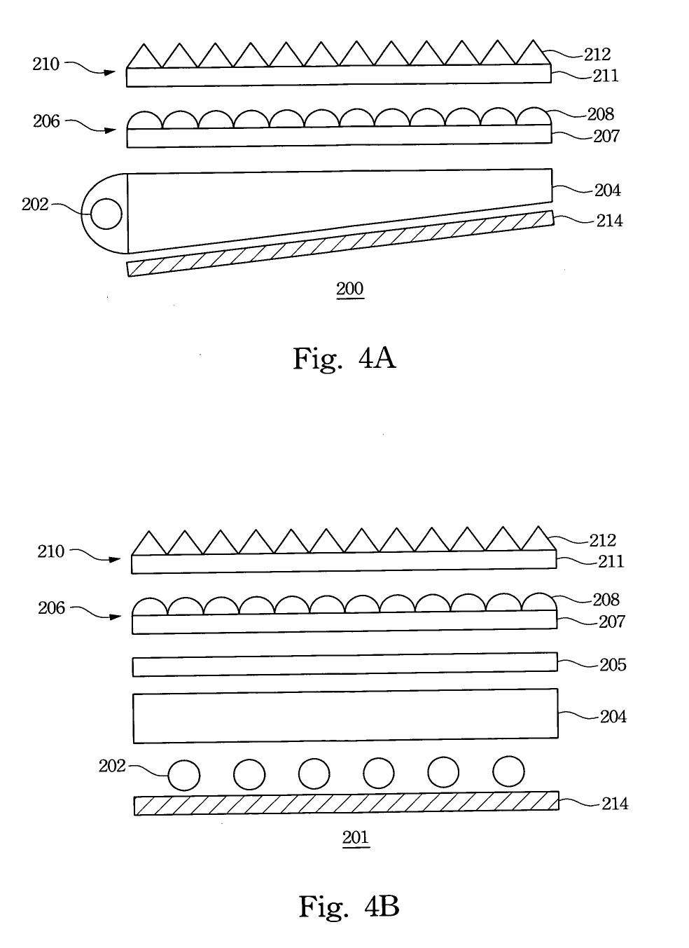

FIG. 4A and FIG. 4B are cross-section schematic diagrams showing a back light module according to one embodiment of the present invention. In FIG. 4A, a backlight module is an edge-side type backlight module 200, which comprises a light source 202, a light guide substrate 204, a first lens array 206, a second lens array 210 and a reflector 214. The light guide substrate 204 is located on one side of the light source 202. The first lens array 206 is located on the light guide substrate 204. The second lens array 210 is located on the first lens array 206. The first lens array 206 comprises a first substrate 207 and a plurality of curved bumps 208 on the first substrate 207, and the second lens array 210 comprises a second substrate 211 and a plurality of pyramid bumps 212 on the second substrate 211.

Alternatively, a backlight module can be a direct type backlight module 201 shown in FIG. 4B. In FIG. 4B, a direct type backlight module 201 sequentially has a reflector 214, a light source 202, a light guide substrate 204, a diffuser plate 205, a first lens array 206 and a second lens array 210 from bottom to top.

Preferred materials for the first lens array 206 and the second lens array 210 mentioned above are those with high visible light transparency, such as glass, polyester and the like. The curved bumps 208 of the first lens array 206 and the pyramid bumps 212 of the second lens array 210 are smaller than micro-scale, preferably smaller than 50 microns in size.

A method of fabricating the first lens array 206 and the second lens array 210 is to first coat a mold with curved structures or pyramid structures or a roller with resin, and then an optical substrate is covered thereon to form the curved structures or the pyramid structures on the optical substrate to form the first lens array 206 and the second lens array 210. The material of the resin has a refraction index above 1.5 preferably. The method of fabricating the first lens array and the second lens array mentioned above is not used to limit the scope of the present invention.

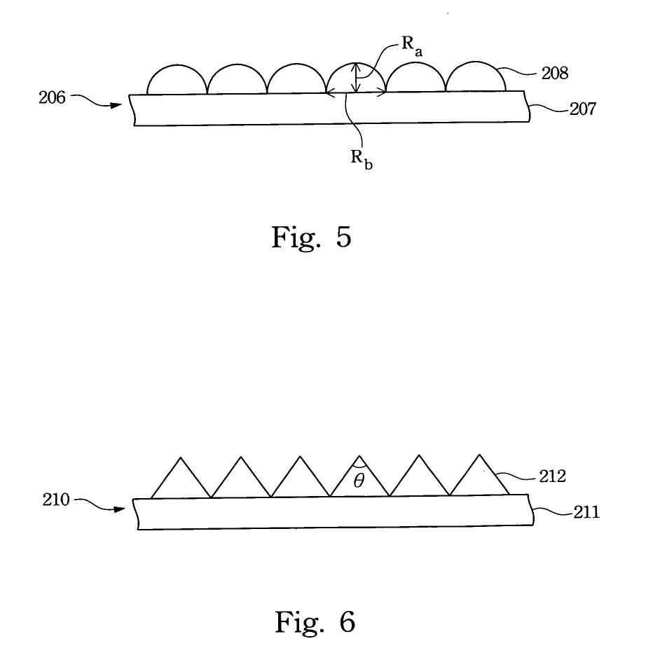

FIG. 5 is a cross-section schematic diagram showing the enlarged first lens array in FIG. 4A. In FIG. 5, the first lens array 206 comprises the curved bumps 208 on the first substrate 207 and cross-sections of the curved bumps 208 are an arc. The curved bumps 208 have the same sizes, which are arranged regularly. The other sizes and the arrangement of the curved bumps 208 can be used according to the demands. The curved bumps 208 have arc height Rₐ and cord length R_{b}, where the ratio of the arc height Rₐ and the cord length R_{b} is preferably between 0.25 and 0.5, and more preferably 0.5. A bottom shape of the curved bumps 208 is preferred round or hexagon and the bottom shape of the curved bumps 208 mentioned above is not a limitation to the scope of the present invention.

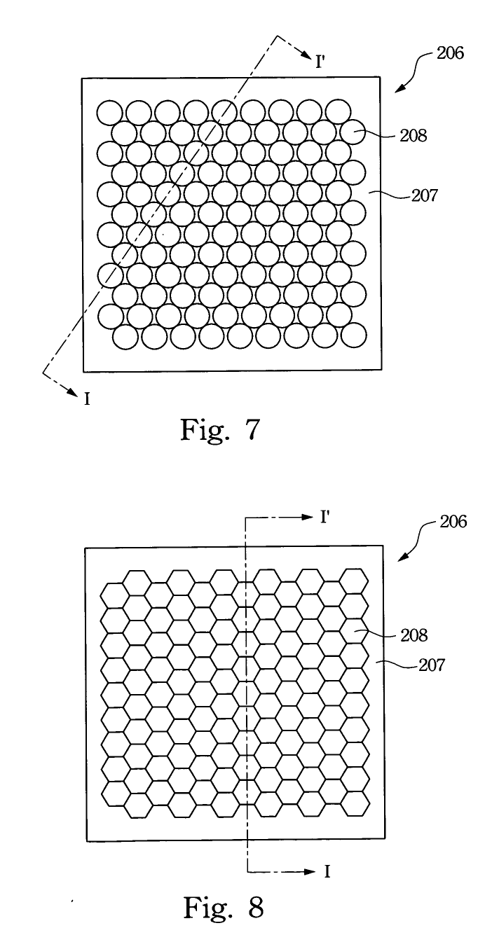

FIG. 7 and FIG. 8 are top view schematic diagrams showing a first lens array according to one embodiment of the present invention. FIG. 5 is a cross-section schematic diagram along the I-I′ line in FIG. 7 or FIG. 8. In FIG. 7, the first lens array 206 comprises the curved bumps 208 on the first substrate 207 and the bottom shape of the curved bumps 208 is preferably round. Alternatively, the bottom shape of the curved bumps 208 on the first lens array 206 is preferably hexagonal as shown in FIG. 8.

FIG. 6 is a cross-section schematic diagram showing the enlarged second lens array in FIG. 4A. In FIG. 6, the second lens array 210 comprises the pyramid bumps 212 on the second substrate 211 and cross-sections of the pyramid bumps 212 are tapered. The pyramid bumps 212 have the same sizes, which are arranged regularly. The other sizes and arrangement of the pyramid bumps 212 can be used according to the demands. The pyramid bumps 212 have pointed tips on the top. An angle θ of the pointed tip on the top is preferably between 60° and 120°, and more preferably 90°. The shape of the bottom of the pyramid bumps 212 is preferably round or square and the bottom shape of the pyramid bumps 212 is not used to limit the scope of the present invention.

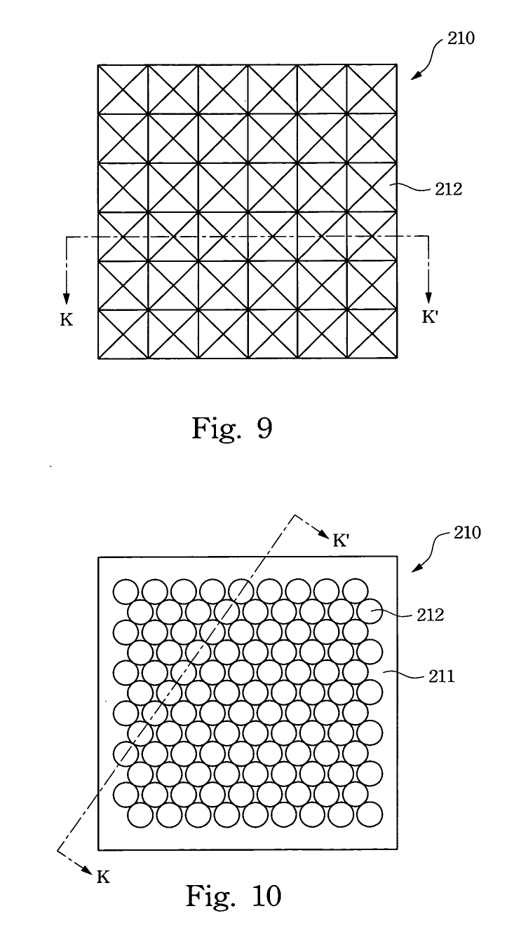

FIG. 9 and FIG. 10 are top view schematic diagrams showing a second lens array according to one embodiment of the present invention. FIG. 6 is a cross-section schematic diagram along the K-K′ line in FIG. 9 or FIG. 10. In FIG. 9, the second lens array 210 comprises the pyramid bumps 212 on the second substrate 211 and the bottom shape of the pyramid bumps 212 is preferably square. Alternatively, the shape of the bottom of the pyramid bumps 212 on the second lens array 210 is preferably round as shown in FIG. 10.

The present invention provides two lens arrays having different bump structures, that is the first lens array 206 has curved bumps 208 and the second lens array 210 has pyramid bumps 212, and the second lens array 210 is located on the first lens array 206 to reduce the moire effect. Moreover, the backlight module of the present invention can increase its brightness to 100% at a certain range of visual angle. That is, the backlight module of the present invention can keep uniform brightness within a visual angle smaller than 300.

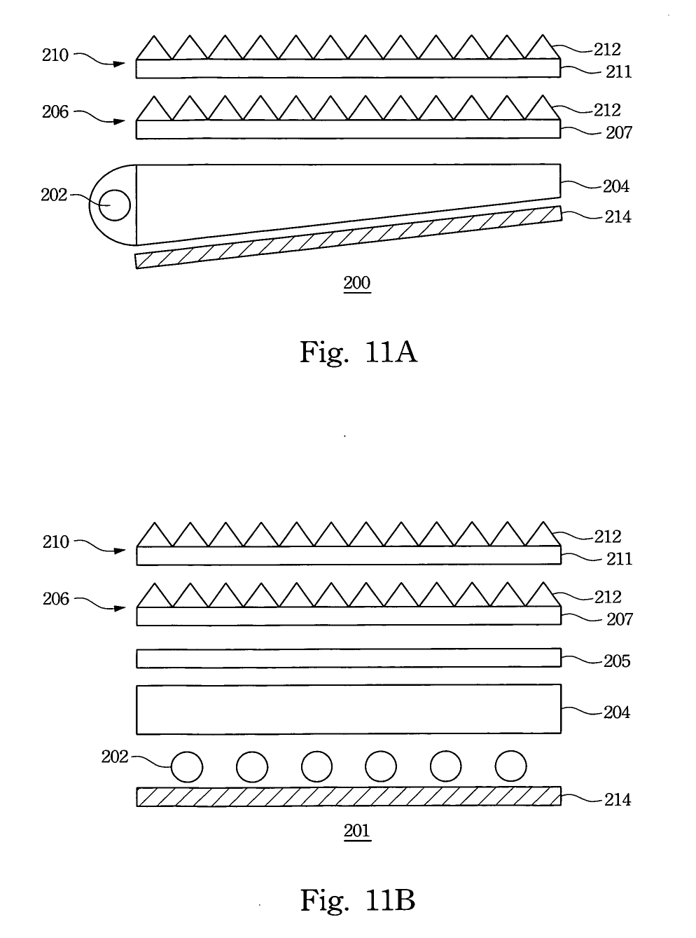

Alternatively, the first lens array 206 comprises the pyramid bumps 212 on a first substrate 207 shown in FIG. 11A and FIG. 11B according to another embodiment of the present invention. Sizes, materials, the bottom shape and the arrangement of the pyramid bumps 212 of the first lens array 206 are preferably the same as the pyramid bumps 212 of the second lens array 210, so the description relating to those materials is not repeated here.

Thus, an optical module of the present invention can increase its brightness at a certain range of visual angle and reduce the moire effect. Moreover, the curved bumps of the first lens array and the pyramid bumps of the second lens array are smaller than micro-scale to be able to both diffuse and focus light. Furthermore, the optical module of the present invention can achieve the effect that conventionally requires four optical elements to achieve, that is the optical module of the present invention can reduce the number of the optical elements used and decrease the material and manufacturing cost. The optical module of the present invention can use two lens arrays with the same pyramid bumps to enhance its brightness.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An optical module, the optical module comprising:
at least a light source;
a first lens array located on the light source, wherein a surface of the first lens array comprises a plurality of curved bumps; and
a second lens array located on the first lens array, wherein a surface of the second lens array comprises a plurality of pyramid bumps.

2. The optical module of claim 1, wherein the curved bumps of the first lens array have a ratio of 0.25 to 0.5 between a curved height and a cord length of the curved bumps.

3. The optical module of claim 2, wherein the curved bumps of the first lens array have the ratio of 0.5 between the curved height and the cord length of the curved bumps.

4. The optical module of claim 1, wherein the pyramid bumps comprise a plurality of pointed tips on the top with an angle between 60° to 120°.

5. The optical module of claim 4, wherein the angle of the pointed tips on the top are 90°.

6. The optical module of claim 1, wherein the curved bumps and the pyramid bumps are smaller than micro-scale.

7. The optical module of claim 6, wherein the curved bumps and the pyramid bumps are smaller than 50 microns in size.

8. The optical module of claim 1, wherein the curved bumps and the pyramid bumps are arranged regularly.

9. The optical module of claim 1, further comprising a light guide substrate under the first lens array.

10. The optical module of claim 9, further comprising a reflector under the light guide substrate.

11. An optical module, the optical module comprising:
at least a light source;
a first lens array located on the light source, wherein a surface of the first lens array comprises a plurality of first pyramid bumps; and
a second lens array located on the first lens array, wherein a surface of the second lens array comprises a plurality of second pyramid bumps.

12. The optical module of claim 11, wherein the first pyramid bumps and the second pyramid bumps comprise a plurality of pointed tips on the top with an angle between 60° to 120°.

13. The optical module of claim 12, wherein the angle of the pointed tips on the top are 90°.

14. The optical module of claim 11, wherein the first pyramid bumps and the second pyramid bumps are less than micro-scale.

15. The optical module of claim 11, wherein the first pyramid bumps and the second pyramid bumps are less than 50 microns in size.
